(19) United States
(12) Patent Application Publication
(10) Pub. No.: US 2026/0154686 A1
(43) Pub. Date: Jun. 4, 2026

(54) SYSTEMS AND METHODS FOR BIOMETRICALLY AUTHENTICATED MULTI-ACCOUNT ACCESS

(71) Applicant: Capital One Services, LLC, McLean, VA (US)

(72) Inventors: Jeffrey Carlyle Wieker, Falls Church, VA (US); Jesse Emery, Arlington, VA (US); Lesley Newton, Richmond, VA (US); Kaitlin Newman, Washington, DC (US); Jeffrey Rule, Chevy Chase, MD (US); Swapna Mandala, Glen Allen, VA (US)

(21) Appl. No.: 18/968,661

(22) Filed: Dec. 4, 2024

(51) Int. Cl. G06Q 20/40; G06Q 20/38

(52) U.S. Cl. CPC G06Q 20/40145; G06Q 20/3821; G06Q 20/3825

(57) ABSTRACT

The disclosed systems and methods are directed to an implementation of a biometrically authenticated centralized access to multiple accounts, via an account-linking platform. The described implementation involves generation, of a reference biometric identifier (RBI) from biometric data scanned from a user associated with a user account stored by the first server. The implementation may further comprise transmission of the generated RBI, to a central server linking a plurality of account servers. The implementation may further comprise generation, by the first device, a biometric data packet (BDP) from biometric data captured from the user, and transmission of the same to the central server. A verification of the BPD, may then be carried out by the central center, based on determining a match between the BDP received from the first device and the RBI received from the first server.

The present disclosure is generally related to implementation of account-linking platforms and more specifically to implementation of biometric authentication in account-linking platform.

### BACKGROUND

Account linking platforms provide central access to a plurality of user accounts associated with a user. Access authentication scheme employed by such platforms are not generally associated with a verification of a unique user identity tied to a single trusted source. Alternatively, such account-linking platform, generally rely upon additional sets of platform-specific authentication operations, such as a challenge-response authentication process for implementing access authentication.

However, such one-time time code and/or challenge based authentications schemes may be susceptible to fraudulent operations. For example, a user device may be stolen and fraudulently used for providing a challenge response (e.g., a one-time code). As another example, an issued challenge message, intended for a user device, may be intercepted and fraudulently forwarded to a different device. Therefore, platforms using challenge-response authentication schemes are based on verification of a user device and accordingly do not provide strong user identity verification.

These and other deficiencies exist. Therefore, is a need for a more secure implementation of user authentication for account-linking platforms.

### SUMMARY OF THE DISCLOSURE

In some aspects, the techniques described herein relate to a method for providing biometrically authenticated centralized access to multiple accounts, the method comprising: generating, by a first server, a reference biometric identifier (RBI) from biometric data scanned from a user associated with an account stored by the first server, wherein the (RBI) is transmitted, along with user identification and payment credentials, to a central server linking a plurality of account servers including the first server; responsive to a user transaction being conducted at a first device, generating, by the first device, a biometric data packet (BDP) from biometric image data retrieved, by the first device, from the user, wherein the BDP is transmitted to the central server; returning, by the central server, payment credentials associated with user from the plurality of servers, based on determining a match between the BDP received from the point of sale (POS) and the RBI received from the first server.

In some aspects, the techniques described herein relate to a system for providing centralized multi-account access based on real-time biometric authentication, the system comprising: a first device comprising: a processor; a memory, and a Sensor for capturing biometric image associated with a user; and a first server connected to a central server trust-linking a plurality of account servers including the first server; wherein the first server is configured to: generate a reference biometric identifier (RBI) from biometric data scanned from the user, wherein the user is associated with an account stored on the first server; transmit the RBI to the central server; wherein the first device is configured to: generate, in response to a transaction being conducted by the user via the first device, a biometric data packet (BDP)from biometric image data scanned from the user; transmit the BDP to the central server for verification against the RBI, wherein upon verification of the BDP one or more user payment credentials associated with user is returned from the plurality of account servers

In some aspects, the techniques described herein relate to a computer-readable non-transitory medium including computer-executable instructions that, when executed by at least one processor, perform procedures including the steps of: generating, by a first server, a reference biometric identifier (RBI) from biometric data scanned from a user associated with an account stored by the first server, wherein the (RBI) is transmitted, along with user identification and payment credentials, to a central server linking a plurality of account servers including the first server; responsive to a user transaction being conducted at a first device, generating, by the first device, a biometric data packet (BDP) from biometric image data retrieved, by the first device, from the user, wherein the BDP is transmitted to the central server; and returning, by the central server, payment credentials associated with user from the plurality of servers, based on determining a match between the BDP received from the POS and the RBI received from the first server.

### BRIEF DESCRIPTION OF THE DRAWINGS

FIG. 1 illustrates a system diagram, according to an example embodiment.

FIG. 2A illustrates a process flow diagram for implementation of biometric authentication by an account-linking platform, according to an example embodiment.

FIG. 2B illustrates a process flow for facilitation of biometric authentication with an authentication source, according to an example embodiment.

FIG. 3A illustrates a timing sequence for implementation of biometric authentication by an account-linking platform, according to an example embodiment.

FIG. 3B illustrates a timing diagram for facilitation of biometric authentication with an authentication source, according to an example embodiment.

FIG. 4 illustrates an exemplary switchboard system implementation according to an example embodiment.

FIG. 5 illustrates a block diagram of an exemplary system according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Conventional multi-account aggregating platforms may be associated with multiple participating service providers based on a pre-established trust relationship. A user may be granted access to multiple user accounts associated with one or more participating service providers based on additional platform-specific user verification methods prior to granting the user access across multiple participating service provider. However, such authentications are generally based on challenge-response format such as a one-time code sent to a registered user device. Upon reception of a matching code into at a password verification screen, access to a multiplicity of user card and/or payment accounts may be provided by an account-linking platform.

In departing from challenge-response scheme for user identification implemented by conventional third-party account-linking platforms, one aspect of the present application is directed to systems and methods for integrating a strong user authentication uniquely tied to a user identity (e.g., biometric authentication) and verifiable against a pre-authenticated identity signature provided by a trusted source (e.g., a participating service provider associated with a user count). In accordance with one aspect of the present disclosure, a pre-authenticated identity signature is established based on a unique biometric signature, associated with a user. The biometric signature may be generated and provided to an account-linking platform by a trusted source (e.g., a participating service provider). The account-linking platform may then associate the biometric signature, provided by a trusted entity (e.g., a participating service provider) with a registered user account associated with the aforementioned service provider (e.g., an account-issuing bank).

Accordingly, one aspect of the present disclosure describes a method for providing biometrically authenticated centralized access to multiple user accounts on an account-linking platform. As described above, an initial step for implementation of such biometric user authentication may involve generation of a unique biometric signature that may serve as a reference biometric identifier (RBI) for a user. Since the account-linking platform interconnects multiple service providers (e.g., financial institutions), one appropriate source for acquisition of the RBI may be a target service provider (e.g., participating financial institutions that store and administers one or more user financial accounts).

In accordance with one aspect of the present disclosure, an RBI may be computed, by a target service provider, based on biometric data measurements taken from a user. The RBI may then be provided to an account-linking platform by an account server managed by the target service provider. For example, the RBI computed from biometric data captured from the user may be transmitted along with user account data, to one or more central account-linking servers aggregating data from a plurality of account servers including the target service provider. Since the target service provider may be a participating member on the account-linking platform, the RBI received may also be linked with user accounts maintained by other participating members on the account-linking platform.

A transaction-related biometric signal (e.g., a biometric signal captured from user at transaction time) may be captured and processed, by a transaction device, into a biometric data packet (BDP). The BDP may be tokenized and/or encrypted for privacy concerns. A transaction device may correspond to a merchant point of sale (POS) device (e.g., a laptop computer, a desktop computer, a tablet, a mobile device (e.g., a smartphone), a wearable device, a kiosk, an automated teller machine (ATM)) and/or a user device (e.g., a user communication and/or computing device such as a laptop computer, a desktop computer, a tablet, a mobile device (e.g., a smartphone), and a wearable device) through which a user is conducting an online transaction at a merchant check out page. The BDP may then be transmitted, along with specific account data provided by the user, to the account-linking platform (e.g., to one or more central servers associated with the account-linking platform). Upon determining a successful match (e.g., in accordance with biometric matching standards established by the target provider) between the BDP received at transaction time and the RBI previously provided by the target service provider, in association with the specific user account, the user may be authenticated by the account-linking platform. Accordingly, a biometric signal generated for a transacting user in association with a user transaction (associated with a specific payment card account) may be verified relative to a pre-established RBI tied to the specific payment card and/or account, thereby enabling an account-linking platform to securely unlock various user payment cards and/or accounts associated with one or more other service providers participating on the account-linking platform.

In this way, by leveraging the trust relationship established among various service providers participating in an account-linking platform, a biometrically authenticated access to one service provider enables the account-linking platform to return account credentials associated with other user accounts from one or more service provider participating on the account-linking platform. The corresponding payment account information, returned by the account-linking platform, may be provided to the user (e.g., displayed on the transaction device) for selection of a desired user account to process the transaction. Upon selection of a desired payment method from the displayed choices, the selected payment credentials may be transmitted, on behalf of a merchant, to the appropriate server/system associated with the selected account, for validation.

As described above, the reference biometric identifier (RBI) may be generated by the same entity (e.g., user account and/or card issuing entity) that provides a user account and/or personal data to a central account-linking platform. During a real-time transaction, a biometric data packet (BDP) may be received from a transaction device and verified against a corresponding RBI In one Scenario verifying the BDP may be performed independently by the account-linking platform. In this example, RBI data received from a trusted source (e.g., device and/or server generating the reference biometric signature) may be stored, in association with a user's payment and/or account provide by the trusted source, on the account-linking platform. The RBI may then be directly accessed and verified by the account-linking platform for access authentication to all user-linked accounts.

However, in some instances, due to privacy concerns and/or operational restrictions, it may not be amenable to store information regarding various biometric signatures generated based on various biometric measurements taken from a user (e.g., retinal scan, iris image, handprint, fingerprint, etc.) on a third-party server (e.g., servers associated with operation of the account-linking platform). Accordingly, in some embodiments, the RBI data may not be provided to an account-linking platform, but instead stored and maintained by the target service provider (e.g., on an account server associated with management of one or more user accounts). In such embodiments, the verification of a BDP, associated with a user transaction, may be facilitated by the account-linking platform via communication with the account server associated with the target service provider. Accordingly, a BDP received from a merchant POS device or a user device is transmitted, by the account-linking platform, to the RBI source (e.g., account server associated with the target service provider) for verification. Upon verifying the received BDP against a locally-stored RBI associated with an identified user account, a verification response comprising, for example, a user and/or account identification token may be sent, by the account server, back to the account-linking platform. The verification response may then initiate the account-linking platform to return payment credentials associated with the user from the plurality of participating service providers.

In some embodiments, a biometric signature corresponding to a RBI for a user and biometric data packet provided in association with a real-time transaction being conducted by the user, may require consistent format for enabling the biometric verification process. However, the BDP, captured at transaction time, may be restricted to a specific format as determined by biometric sensing capabilities of the transaction device (e.g., a merchant POS device or a user device). Accordingly, in order for the biometric verification process to be compatible with a variety of sensing capabilities incorporated across various POS and/or user devices, the biometric signature may be generated as a multi-mode biometric signature associated with a plurality of reference biometric identifiers (RBIs), such that each RBI may be associated with different biometric measurements captured from a user (e.g., fingerprint, iris image, retinal scan, handprint). Accordingly, the biometric verification process may comprise an additional step to identify a format and/or type associated with an incoming BDP, and determination of an RBI with a matching type and/or format from the multi-mode biometric signature prior to performing the matching and/or comparison operation.

In some embodiments, the verification of a BDP may be based on closeness of a match with a previously established RBI for a user. In some embodiments a user biometric signature with a consistent format may be submitted by several participating service-provider. In such a scenario the matching of a BDP may be carried out against a plurality of RBIs across different service-providers associated with the user (e.g., service providers that have submitted an RBI in accordance with a specific format (e.g., retinal scan and/or an iris image)—the matching may then be computed based on degree correlation with the one or more RBIs provided by the participating service providers.

As describes above in accordance with one aspect of the disclosure, the reference biometric identifier may be generated by a trusted entity associated with a user and submitted in conjunction with corresponding user payment account data, to an account-linking platform. Alternatively, the RBI may be provided by a user via, for example, a user device. In such scenarios, raw biometric data may be retrieved by, for example, a camera unit associated with a user mobile device and processed into a reference biometric identifier by an image and/or data processing application executing on the user mobile device, prior to being submitted to the account-linking platform by the use. In such a scenario, in order to authenticate that the reference biometric data is being submitted by an authorized user, an additional authentication may be requested in association with the reference biometric data. In some embodiments the additional authentication may be provided by a one-time password (OTP) generated by a contactless card associated with the user. In some embodiments, the OTP may be retrieved from the contactless card by a user communication device and transmitted to the central server along with the BDP. The user communication device may be configured to communicate with the contactless card using near-field communication (NFC).

In some embodiments, the RBI, generated by a target service provider, may be processed into a format that can be stored, in an encrypted or non-encrypted form, on a user device such as a contactless card. Such an RBI may correspond to, for example, a vectorized and compacted retinal scan or iris image data that may be stored on the contactless card. The RBI stored on the user's contactless card may then be retrieved by a transaction device (e.g., POS or a user device) configured with NFC functionality. In accordance with one embodiment, the RBI retrieved from the contactless card may be compared with a BDP, such as a retinal scan or iris image data, generated by the transaction device configured with appropriate biometric sensing capability.

In some embodiment the BDP received, for example, in conjunction with a transaction request (e.g., as part of the transaction request 126), may then matched with an identified service-provider user account and compared with an RBI associated therewith (e.g., RBI 108). Upon meeting a pre-determined matching threshold, access to specific user account as well as other accounts connected to user 103, across participating service-providers (e.g., 111-113), is granted to user 103. In some embodiments, biometric data matching process (e.g., between BDPs and RBIs) may be optimized by implementing pattern learning and data matching routines, for example to rapidly identify and classify effective data structures representing unique features, using machine learning models, such as convolutional neural networks (CNN).

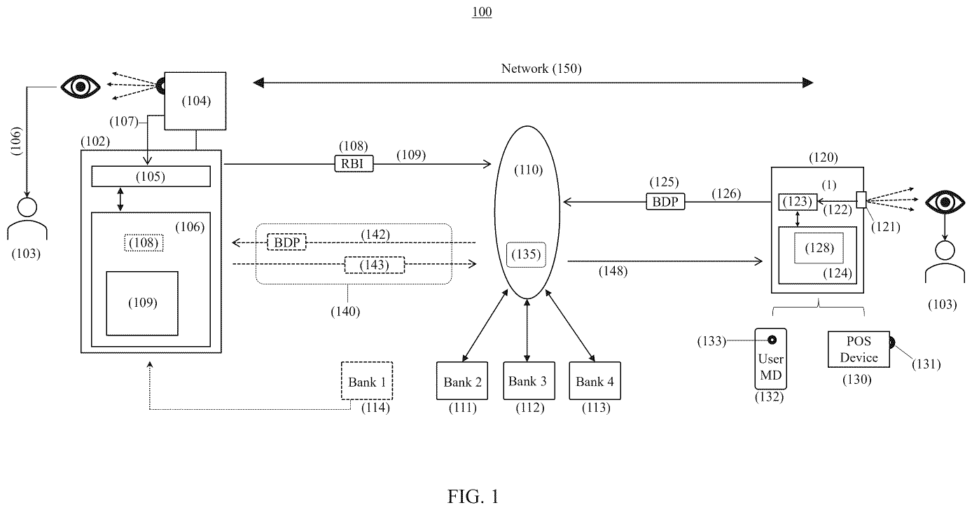

FIG. 1 illustrates an example system 100 according to an example embodiment. Although FIG. 1 illustrates single instances of components of system 100, system 100 may include any number of components. System 100 comprises a first server 102 corresponding to a trusted source for providing the RBI (e.g., the target service provider). In some embodiments, the first server may correspond to an account server storing a one or more user accounts belonging to user 103. System 100 further comprises a first device 120 corresponding to a transaction device with biometric data acquisition unit 121. Transaction device may correspond to a merchant POS device 130 configured with a biometric reader unit 131 or a user communication device 132 with a camera unit 132. The camera unit 132 may be used, for example, to obtain an iris image from which a biometric data packet may be generated. System 100 may further comprise an account-linking central platform 110 (e.g., comprising of one or more central servers) for inter-connecting several service-providers (e.g., 111, 112, 113, 114), as well as a network 150 which interconnects the various components of system 100.

The first server 102 provides a reference biometric signature 108, for user 103, to the account-linking platform 110. User 103 may be an account holder for one or more accounts administered and/or managed by a service provider associated with the first server 102. In some embodiments a service provider may represent a financial institution, such as a bank, and/or an issuing entity for one or more payment cards associated with a (e.g., user 103). In example 100, the first server 102 is communicatively coupled to one or more biometric sensors 104. In some embodiments, the one or more biometric sensors, for capturing one or more raw biometric data signals from a user, may be integrated onto the first server 102. Referring back to FIG. 1. the first server 102 may generate a reference biometric signature from raw biometric data 106 retrieved from user 103. Raw biometric data may correspond to scan of unique pattern of renal blood vessels and/or an acquisition of one or more iris images (e.g., for iris recognition) as captured from user 103. The raw biometric data 106 may then be used for generation of reference biometric signature/identifier that may be used in biometric identification of user 103.

Accordingly, with reference to exemplary system 100, first server may be configured with one or more biometric sensors 104. In order to establish a reference biometric signature for the user, from raw biometric data 106 retrieved by the one or more biometric sensors 104. The captured data 106 is processed by the first server into a reference biometric identifier (RBI). In some embodiments processing of user-captured biometric data into a reference biometric signature may comprise an image vectorization process to generate a vectorized image of one or more unique features of the biometric feature, such a retina of the eye. (e.g., branching blood vessels pattern). In one embodiment, the raw biometric data, captured by the one or more sensors 104, may be processed internally into a desired format (107), prior to being communicated to a processor of the first server 102. For example, input biometric data (e.g., 106) may be processed into an appropriately formatted signal (107) optimized for representing a reference biometric signature/identifier (108), prior to being provided to first server (102).

Referring back to exemplary system 100, a unique reference biometric identifier (e.g., RBI 108) is generated for user 103. The generated RBI may be stored on the first server 102 and provided along with user payment credentials to a central account-linking platform 110 connecting a plurality of service-providers (e.g., 111, 112, 113), including the servicer-provider 114 associated with the first server 102. The account-linking platform 110 may be implemented as one or more central servers communicatively coupled with a plurality service providing servers based on a pre-established trust relationship. The plurality of service providing servers may correspond to various account servers managing different financial accounts associated with a user.

User biometric signature may then be registered, along with required user account data, with the account-linking platform 110, (e.g., represented by registration signal 101 in FIG. 1). Transaction-side operation are represented by first device 120. First device 120 device may correspond to any device by means of which a user transaction and/or a transaction request is initiated. Accordingly, exemplary system 100 further illustrates a first device 120 associated with transaction-side operations, in accordance with some embodiments. First device 120 may be equipped with a biometric sensor 121 for capturing a biometric signal 122 from user 103. First device 120 may further comprises a processor 123 and memory 124 for processing the biometric signal 122 into a biometric data packet 125. The first device 120 may transmit the biometric data packet 124, along with user-provided data as part of a transaction process initiated by user 103. The user-provided data may be associated with identification of user 103 and/or a user account associated with user 103 (e.g., user account data may be provided by a user payment card managed by service-provider 114).

In some embodiment, a receiving process, associated with the account-linking platform, may compare a received BDP data (e.g., for authentication of a user transaction request) with a plurality of user-specific RBIs that may be provided by a plurality of account servers associated with the user and participating on the account-linking platform. A validation of the transaction request may be based on a threshold number of successful and/or unsuccessful matches between the received BDP and the RBIs made available by various distinct account servers. In some embodiments, validation threshold may be determined based on security requirements of a merchant providing the BDP as an authentication factor and/or an account service provider providing the RBI for a user.

In some embodiments, the transaction-initiating device (e.g., first device 120) may correspond to a merchant POS device 130 equipped with a biometric sensing unit 131, wherein the BDP is computed from biometric data retrieved by the biometric sensor 131. The BDP is then transmitted to the account-linking platform 110, in association with an in-person transaction conducted by user 103 at a merchant POS device (e.g., POS device 130). In some embodiments, the BDP generated by a merchant POS device may further comprises a digital signature associated with the merchant. The digital signature may be implemented using a public key cryptography protocol and used for validating a merchant's identity. In such a scenario, a transmission message 126 containing the BDP may be encrypted with a private key of a particular merchant and verified by the account-linking platform using a corresponding public key.

In some embodiments, the transaction initiating device (e.g., first device 120) may correspond to a user computing and/or communication device (e.g., user mobile device 132 used for by user 103 for conducting an electronic transaction at an online checkout page). Accordingly, the retrieval and processing of the raw biometric data into a BDP may be carried out by the user mobile device 132. In this case, raw biometric data (e.g., image of the iris) may be correspond to image data captured by camera unit 133 integrated onto the user device. The captured image data My then be processed by one or more application executing on the user device (e.g., applications 128) into a biometric data packet (BDP).

Referring back to exemplary system 100, a transaction request message 126, transmitted by the first device 120, may comprise the BDP 125 and one or more user account credentials provided by user 103 at transaction time. Upon receiving the transaction request 126, a specific user account may be identified from the account information included in the transaction request. Following identification of a corresponding user account, an internal biometric verification process 135 may be undertaken by the account-linking platform 110 (e.g., one or more central servers associated with the account-linking platform 110). In this example, the biometric verification process is independently conducted by the central platform, based on the RBI data previously received from first server 102 (e.g., device and/or server providing the reference biometric signature and user account data) and stored by the account-linking platform 110. Accordingly, with reference to the internal biometric verification 135, the RBI data is directly accessed and matched against the BDP included in the transaction request. If a biometric match is determined between the BDP, received at transaction time, and a corresponding RPI associated with the user account (provided previously by a corresponding service provider) a user may be authenticated for access to account data administered by the first server 102 (associated with the target service provider 114), as well as other user associated accounts associated with other service providers (e.g., 111-113) participating on the account-linking platform 110.

In some embodiments, user biometric signatures may not be provided to an account-linking platform and instead stored and maintained by the first server (e.g., server associated with management of one or more user accounts). In such cases, an external biometric verification process 140 may be undertaken by the account-linking platform 110. During an external biometric verification process 140, the biometric verification may be performed by an account issuing server (e.g., first server 102). In such embodiments, the RBI data is not provided to the account-linking platform 110 and instead maintained by the source system 114 (e.g., on first server 102). The BDP received from first device 120 (e.g., merchant POS device 130 or user mobile device 132), is communicated (e.g., via transmission 142), by the account-linking platform 110, to the first server 102 for verification.

Accordingly, an external biometric verification process (e.g., 140) may comprise transmitting, by the central server, the BDP to the first server, wherein the BDP received from the central server, is compared with one or more RBIs stored on the first server 102 for a verification. In response to a successful match, the first server 102 can verify by sending an identifier token 143 associated with the matching RBI to the account-linking platform 110.

Referring back to FIG. 1, the BDP received, for example, in conjunction with a transaction request (e.g., as part of the transaction request 126), may then matched with an identified service-provider user account and compared with an RBI associated therewith (e.g., RBI 108). Upon meeting a pre-determined matching threshold, access to specific user account as well as other accounts connected to user 103, across participating service-providers (e.g., 111-113), is granted to user 103. In some embodiments, account identification data 148, corresponding to various user accounts managed by different service providers, may be presented to the user on first device 120. User 103 may select a desired account from among the presented choices (service providers 111-114), and the transaction is then processed through the selected service provider. With reference to FIG. 1, the selected account may correspond to first server 102 (associated with service provider 114) or one of the other service providers (111-113).

In accordance with some embodiments, the biometric signal 121, captured by first device 120 at transaction time, may be of any format that is supported by system 100. Accordingly, system 100 may be compatible with a variety of sensing capabilities incorporated across various POS and/or user devices. In some example multiple RBIs for a user may be provided by the first server 102 (e.g., fingerprint, iris image, retinal scan handprint). In this way, POS devices with different biometric measurement capabilities may be used in exemplary system 100. A format/type associated with an incoming BDP can be determined by central platform 110 and/or first server 102, and a corresponding RBI of matching type/format may then be identified for verification of the BPD.

As described above, with reference to FIG. 1, the first device may correspond to a Point of sale (POS) device for receiving and processing payment transactions associated with purchase and/or payment operations at a merchant. The POS device may include one or more sensors for capturing one or more biometric signal from a user. For example, an iris scan may be conducted using an optical and/or Infra-red imager and/or sensor. POS device may store one or more application for operating the one or more sensor and/or processing the received biometric signal, into, for example biometric data packet that is transmitted remotely for authentication.

In some embodiments, the first device for capturing and processing a biometric signal (e.g., as access authentication during a real-time transaction) may correspond to a user computing and/or communication device (e.g., mobile device 132) and the biometric signal may correspond to a biometric image data captured by a camera unit associated with the user communication device. The user mobile device 132 may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first server 102 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first server 102 may include a processor 105, a memory 106, and one or more applications 109. The processor 105 may be a processor, a microprocessor, or other processor, and the server 102 may include one or more of these processors. The processor 105 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 105 may be coupled to the memory 106. The memory 106 may be a read-only memory, write-once read-multiple memory or read/write memory, e.g., RAM, ROM, and EEPROM, and the server 102 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 106 may be configured to store one or more software applications, such as the applications 109, and other data, such as user's private data and financial account information.

The application 109 may comprise one or more software applications comprising instructions for execution on the server 102. In some examples, the server 102 may execute one or more applications, such as software applications 109, that enable, for example, network communications with one or more components of the system 100, transmit and/or receive data, and perform the functions described herein. Upon execution by the processor 105, the application 109 may provide the functions described in this specification, specifically to execute and perform the steps and functions in the process flows described below. Such processes may be implemented in software, such as software modules, for execution by computers or other machines. The application 109 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 102 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the server 102 that can be available and supported by the server 102, such as a touch-screen, keyboard, mouse, cursor-control device, touch-screen, microphone, digital camera, video recorder or camcorder. These devices may be used to enter information and interact with the software and other devices described herein.

System 100 may include one or more networks 150. In some examples, the network 150 may be one or more of a wireless network, a wired network or any combination of wireless network and wired network and may be configured to connect the first device 120 (e.g., mobile device 132 and/or POS device 130), the server 102 and the account-linking platform 110. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the first device 120, the user device 110, the first server 120, one or more central servers associated with the account-linking platform 110, and the network 150, or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. Additionally or alternatively, a storage arrangement can be provided separately from the computer-accessible medium, which can provide the instructions to the processing arrangement so as to configure the processing arrangement to execute certain exemplary procedures, processes, and methods, as described herein above, for example.

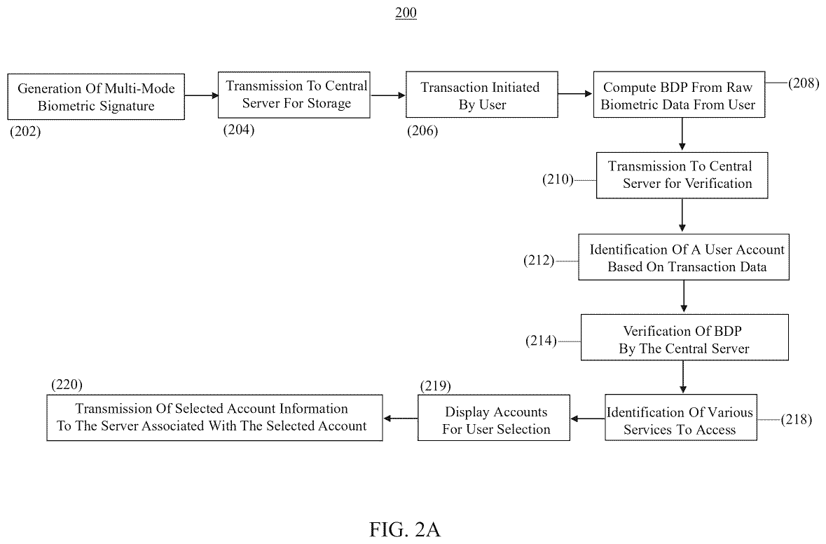

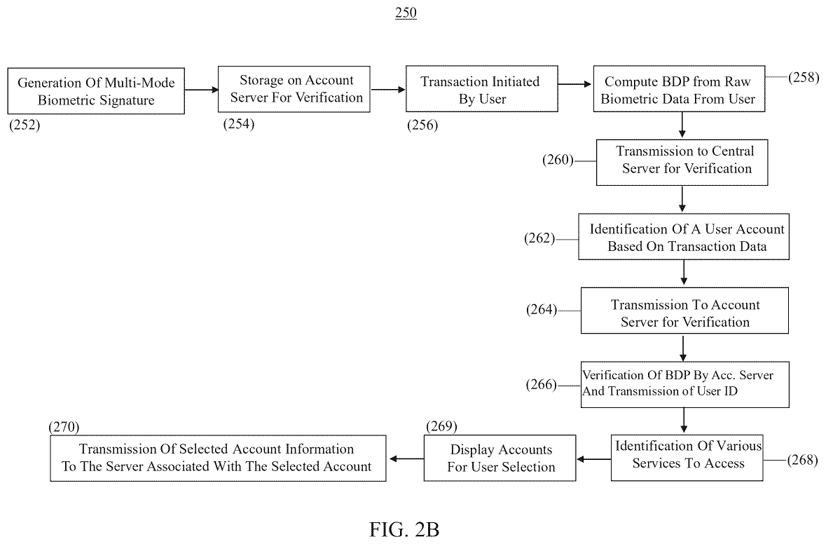

FIG. 2 illustrates an exemplary flow diagram 200 for a biometrically authenticated multi-account access process 200. At step 202 a biometric signature is generated for a user, The biometric signature may correspond to a reference biometric data (RBI) generated for a user associated with an account provider. The RBI may then be provided by the account provider, along with a user's payment credentials, to an account-linking platform (e.g., a third-party platform), as shown by step 204. The user's biometric signature may then be registered, along with required user payment credentials and/or account data, with the account-linking platform. In some embodiments, the reference biometric identifier of a user may correspond to a multi-mode biometric signature. For example, a multi-mode biometric signature may correspond to multiple distinct biometric measurements (e.g., a retinal scan, iris image, hand/fingerprint scanner, voice recognition, etc.) associated with distinct biometric attributes of a user (e.g., retinal blood vessel patterns, texture/color of the iris, pitch and/or/tone of voice, fingerprint etc.). Accordingly, an RBI may correspond to a multi-mode biometric signature (e.g., an aggregation of distinct biometric signatures). Such a multi-mode biometric signature constitutes a more robust reference biometric identifier for a user as it can accommodate a variety of measurement modalities that may be available during a real-time authentication, for example, at a POS device. For example, a user associated with a multi-mode or aggregated reference biometric identifier may be authenticated at a merchant POS using a handprint reader, a retinal scanner and/or voice recognition depending on biometric measurement capabilities available.

Steps 206-210 correspond to transaction-side operations conducted by a merchant POS device and/or a user's device. At step 206 a transaction may be initiated by the user. The transaction may correspond to an in-person transaction conducted at a merchant POS device or an online transaction conducted via the user's device. The transaction may be initiated with account data associated with the account provider (e.g., account provider associated with the biometric signature that was provided to an account-linking platform at steps 204). At step 208, a biometric data packet may be generated by the transaction-facing device (e.g., a merchant POS or a user device) from raw biometric data captured, by one or more biometric sensors of the transaction-facing device, from the user. At step 210, a transaction request message comprising the BDP and one or more provided account credentials, provided by the user at transaction time, is transmitted to the account-linking platform.

Upon receiving the transaction request, the account-linking platform may use the account information, included in the transaction request, to identify a specific user account, at step 212. Following identification of the user account, an internal biometric verification operation may be conducted by the account-liking platform, at step 214. The verification process may be based on the BDP included in the transaction request. Accordingly, a biometric signature (e.g., the RBI provided at step 204) associated with the user account, identified at step 212, may be accessed by the account-linking platform, and compared to the BDP included in the transaction request received at step 210.

As described previously, the BDP, captured by a transaction-facing device at transaction time, may be of any format as defined by biometric sensing capabilities of the transaction-facing device. Accordingly, in order for the biometric verification process to be compatible with a variety of sensing capabilities incorporated across various POS and/or user devices, the RBI may comprise multiple biometric signatures associated with different biometric measurements for a user (e.g., fingerprint, iris image, retinal scan handprint). Accordingly, the biometric verification step 214 may comprise an additional step to identify a format and/or type associated with an incoming BDP, and determination of corresponding RBI of matching format and/or type, prior to performing the verification at step 214.

If a biometric match, between the BDP, received at transaction time, and a corresponding RBI, associated with the identified user account, is determined at step 214, the process moves to step 218, wherein various user account associated with other participating service-providers associated with the account-linking platform is identified, and based on a trust-relationship established between various member service-providers, a user is authenticated to access to account data provided by the various service providers. At step 219, account identifiers for a plurality of user accounts associated with different service-providers participating in the account-linking platform, is provided to the user (e.g., displayed on the transaction-facing device, such as the merchant POS device or a user mobile device) for selection of a desired account for processing of the transaction. At step 220, account credentials associated with the user-selected account is transmitted, by the account-linking platform, to one or more account servers associated with the selected account.

In the example 200, the biometric verification process is independently conducted by the central platform, based on the RBI data previously received from the account provider in step 204 (e.g., device and/or server providing the reference biometric signature and user account data) and stored by the account-linking platform 110. Accordingly, with reference to the internal biometric verification 135, the RBI data is directly accessed and matched against the BDP included in the transaction request (Step 208). However, in accordance with some embodiment, due to privacy concerns and operational restrictions, a user's biometric signature (corresponding to a single RBI and/or multiple RPIs representing different biometric characteristics) may be maintained on the an account server associated with the user account. Accordingly, biometric verification may not be performed internally on an account-linking platform, but instead performed by an account server corresponding to the source of the biometric signature. This example is illustrated in FIG. 2B.

FIG. 2B illustrates an exemplary flow diagram for a biometrically authenticated multi-account access process 250. At step 252 a multi-mode biometric signature is generated for a user. The biometric signature may correspond to a reference biometric data (RBI) generated for a user associated with an account provider. The RBI may then stored, along with a user's payment credentials and/or account data, on the account server, as shown by step 254.

Referring back to example 250, steps 256-260 correspond to transaction-side operations conducted by a merchant POS device and/or a user's device. At step 256 a transaction may be initiated by the user. The transaction may correspond to an in-person transaction conducted at a merchant POS device, or an online transaction conducted via the user's device. The transaction may be initiated with account data associated with the account provider (e.g., account provider associated with the biometric signature that was stored to the account server at steps 254). At step 258, a biometric data packet may be generated by the transaction-facing device (e.g., merchant POS or a user device) from raw biometric data captured, by one or more biometric sensors of the transaction-facing device, from the user. At step 260, a transaction request message comprising the BDP and one or more account credentials, provided by the user at transaction time, is transmitted to the account-linking platform.

Upon receiving the transaction request, the account-linking platform may use the account information, included in the transaction request, to identify a specific user account, at step 262. Following identification of the user account, an external biometric verification operation may be facilitated by the account-liking platform, as shown by steps 264 and 266. Accordingly, at step 264, the BDP along with user/account identifying information included in the transaction request, is forwarded to the account server (e.g., account server associated with steps 252 and 254). At step 266, a biometric signature (e.g., RBI generated and stored at steps 252 and 254) associated with the user/account identifying information, is accessed by the account server, and compared to the BDP received from the account-linking platform at step 264.

As described previously, the BDP, captured by a transaction-facing device at transaction time, may be of any format as defined by biometric sensing capabilities of the transaction-facing device. Accordingly, in order for the biometric verification process to be compatible with a variety of sensing capabilities incorporated across various POS and/or user devices, the RBI may comprise multiple biometric signatures associated with different biometric measurements for a user (e.g., fingerprint, iris image, retinal scan, handprint, fingerprint). Accordingly, the biometric verification step 266 may comprise an additional step to identify a format and/or type associated with an incoming BDP, and determination of corresponding RBI of matching type/format, prior to performing the verification at step 266.

If a biometric match, between the BDP, received from the account-linking platform at transaction time, and a corresponding RBI, associated with the identified user account, is determined at step 266, a verification response comprising, for example, a user identification token is transmitted back to the account-linking platform. In response to receiving the user identification token from the account server, various user account with other participating service-providers may be identified by the account-linking platform at step 268. Based on a trust-relationship established between various member service-providers, the user may then be authenticated for access to account data provided by the various service providers. At step 269, account identifiers for a plurality of user accounts associated with different service-providers participating in the account-linking platform, is provided to the user (e.g., displayed on the transaction-facing device, such as the merchant POS device or a user mobile device) for selection of a desired account for processing of the transaction. At step 270, account credentials associated with the user-selected account is transmitted, by the account-linking platform, to one or more account servers associated with the selected account.

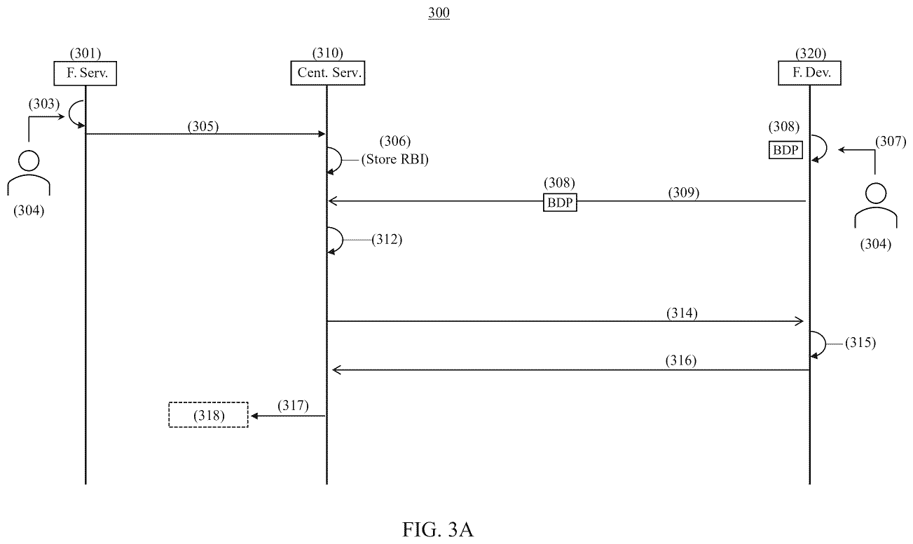

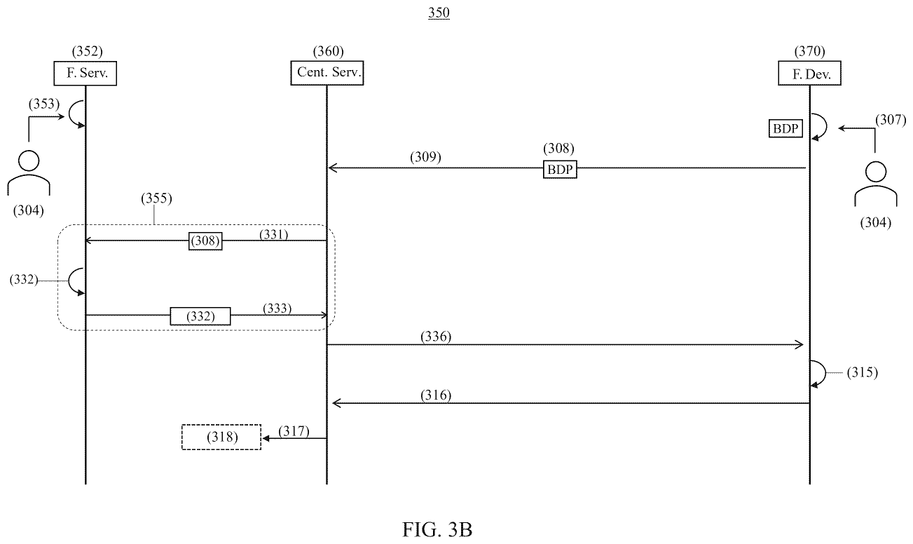

FIG. 3A illustrates a timing sequence diagram 300 associated with an exemplary implementation of a biometrically authenticated multi-account access process. Referring to example 300, a first server 301 (corresponding to an account server associated with user 302) generates a biometric signature 303 from raw biometric data captured from user 304. The biometric signature may correspond to a reference biometric identifier (RBI) generated by an account provider (e.g., an account provider associated with first server 301) based on a measured biometric attribute of user 304. In some embodiments, the biometric signature 303 may correspond to a multi-mode biometric signature, comprising multiple RBIs based on measurements of multiple distinct biometric features associated with user 304 (e.g., retinal scan, iris image, handprint, fingerprint, etc.) The biometric signature may then be provided by the account provider (e.g., first server 301 associated with the account provider), along with a user's payment credentials, to a central server 310 associated with an account-linking platform (e.g., a third-party platform), as shown by process step 305. User biometric signature may then be registered, along with required user payment credentials and/or account data, with the account-linking platform, as shown by process step 306.

Referring back to example 300, process steps 307-309 correspond to transaction-side operations conducted by a transaction-facing device (e.g., first device 320). First device 320 may correspond to a merchant POS device and/or a user's device. At step 307 a transaction may be initiated by the user at the first device 320. The transaction may correspond to an in-person transaction conducted at a merchant POS device, or an online transaction conducted via the user's device. The transaction may be initiated with account data associated with the first server 301. A biometric data packet (BDP) 308 is then generated by the transaction-facing device 320 (e.g., merchant POS or a user device) based on raw biometric data captured from user 304, at transaction time. A transaction request message 309 comprising the computed BDP 308, and one or more user-provided account credentials, is transmitted to the central server 310 associated with the account-linking platform.

Upon receiving the transaction request 309, the central server 310 may use the account information, included in the transaction request, to identify a specific user account. Following identification of the user account, an internal biometric verification operation 312 may be conducted by the central server 310. The internal biometric verification operation 312 may correspond to a comparison of the received BDP 309, included in the transaction request, with the biometric signature 303 provided by the first server 301.

If a biometric match, between the received BDP 308 and a corresponding RBI 303, is determined, a message 314 is transmitted by the central server 310 to first device 320. Message 314 may include account identifiers to various user accounts, for user 304, associated with participating service-providers connected to the central server (e.g., service providers affiliated with the account-linking platform). Message 314 may initiate the first device 320 to display the various account identifiers to user 304. User selection operation 315 performed at the first device 320, may identify a target account associated with a participating service-providers for processing of the transaction associated with the transaction request 307. User selection data 316 is then transmitted back to the central server 310. The central server 310 may then transmit a transaction request 317, with the required account credentials and transaction information associated with the user-selected account, to one or more account servers 318 associated with the selected user account.

As described earlier, the biometric verification may not be performed internally on an account-linking platform, as shown by operation 312, but may instead be delegated to a source system responsible for the generation of the biometric signature 303 (e.g., first server 301). This example is illustrated in FIG. 3B.

FIG. 3B illustrates a timing sequence diagram 350 associated with an exemplary implementation of a biometrically authenticated multi-account access process. Referring to example 300, a first server 352 (corresponding to an account server associated with user 304) generates and stores a biometric signature 353 for user 304. The biometric signature may correspond to a reference biometric identifier (RBI) generated by an account provider (e.g., an account provider associated with first server 352) based on a measured biometric attribute of user 304. In this example, user biometric signature 353 is not registered, along with user payment credentials and/or account data, with the account-linking platform (e.g., central server) but instead maintained and managed by the first server 352.

Referring back to example 350, process steps 307-309 correspond to transaction-side operations conducted by a transaction-facing device (e.g., first device 320), as described in relation to FIG. 3A. Accordingly, a biometric data packet (BDP) 308, generated for user 304 at transaction time, is included in a transaction request message 309 and transmitted to the central server 360 associated with the account-linking platform.

Upon receiving the transaction request 309, the central server 360 may use the account information, included in the transaction request 309, to identify a specific user account. Following identification of the user account, an external biometric verification operation 355 may be facilitated by central server 360 via communication with the first server 352. Accordingly, a message 331, comprising user account data along with BDP 308, received from the first device, is transmitted, by the central server 360, to the first server 352. First server 352 identifies a corresponding, locally stored, user account and performs a comparison between the received BDP 308, included in transmission message 331, with a corresponding biometric signature 353 associated with the locally stored user account. If a biometric match, between the received BDP 308 and the locally stored biometric signature 353 is determined by the first server 353, a verification message 333 comprising, for example, a user identification token 332 is transmitted to the central server 360.

Upon receiving the verification message 333, a notification message 336 comprising for example, account identifiers to various user accounts (e.g., associated with service providers participating in the account-linking platform), for user 304, is transmitted by the central server 360 to the first deice 370. The notification message 336 may initiate the first device 370 to display the various account identifiers to user 304. User selection operation 315 performed at the first device 320, may identify a target account associated with a participating service-providers for processing of the transaction associated with the transaction request 307. User selection data 316 is then transmitted back to the central server 360. The Central server 360 may then transmit a transaction request 317, comprising transaction data associated with user transaction request 307, and account credentials associated with the user-selected account, to one or more account servers 318 associated with the selected user account.

As described previously, the BDP, captured by a transaction-facing device at transaction time, may be of any format as defined by biometric sensing capabilities of the transaction-facing device. Accordingly, in order for the biometric verification process to be compatible with a variety of sensing capabilities incorporated across various POS and/or user devices, the biometric signature may be a multi-mode biometric signature associated with a plurality of reference biometric identifiers (RBIs), such that comprise each RBI is associated with different biometric measurements captured from user 304 (e.g., fingerprint, iris image, retinal scan handprint). Accordingly, the (internal) biometric verification step 312 and/or the (external) biometric verification step 355, may comprise an additional step to identify a format and/or type associated with an incoming BDP 308, and determination of an RBI with a matching type and/or format from the multi-mode biometric signature (e.g., 303 and/or 353), prior to performing the matching and/or comparison operations.

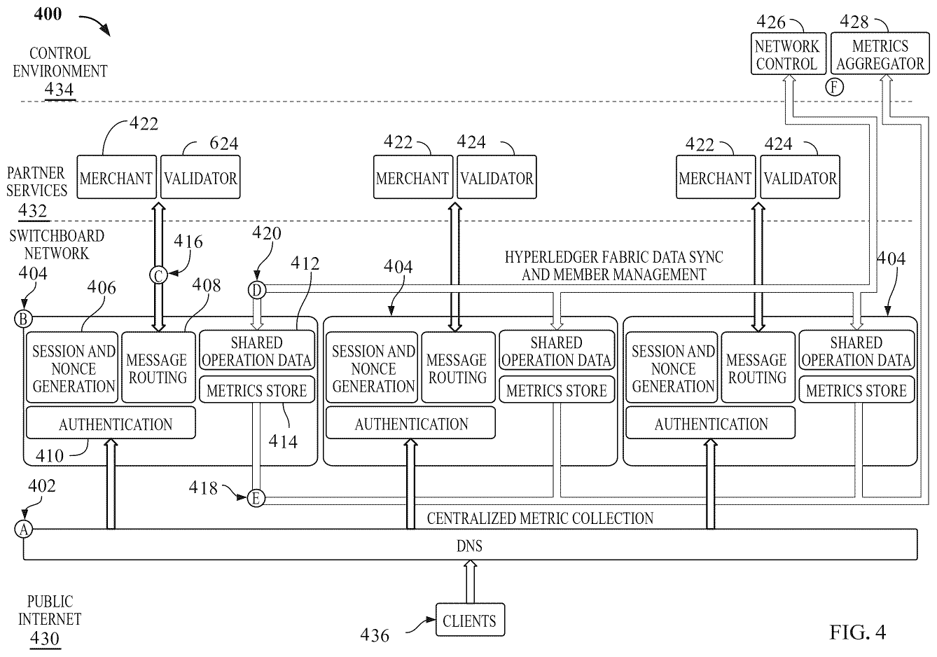

In some embodiments an account-linking platform may be implemented by an switchboard system as illustrated in FIG. 4. FIG. 4 illustrates an example of a switchboard-based system 400 in accordance with the embodiments discussed herein. The system 400 includes additional devices and systems configured to enable biometric identity validation and other services to one or more client entities 436. Client entities 436 may correspond to a transaction-facing device (e.g., first device as described with reference to FIGS. 1-3) initiating a transaction request with a biometric data packet captured from a user at transaction time. Specifically, system 400 enables any number of issuer systems to provide biometric identity validation and control services to their clients through a switching fabric, i.e., the switchboard system in a secure and safe manner.

In some embodiments, the switchboard system includes one or more nodes 404 configured to perform routing operations. Each switchboard node 404 may include a session and nonce generator 406, a message router 408, a biometric authentication function 410, an operation data 412 store, and a metrics store 414. Further, each of the nodes may be configured the same and share configurations, but each switchboard node 404 may independently process and route messages and requests to the appropriate systems. Each of the nodes 404 is configured to act as a broker of trust between an client device 436, merchant system 422, and/or validation system 424, for example. Each switchboard node 404 is configured to route each message to the correct issuer system while maintaining data security. For example, a switchboard node 404 may route a message between an issuer system and client device while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 404. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 404 may operate in a cloud-based computing environment, e.g., a collection of hardware, software, and networking components that enable the delivery of cloud computing services. The switchboard nodes 404 and the computing services are delivered over the Internet, and they can be accessed from anywhere in the world with an Internet connection. In embodiments, a client 436 may access a switchboard node 404 through Domain Name System 402 or domain name system (DNS). The DNS 402 a hierarchical and distributed naming system for computers, services, and other resources connected to the Internet or other networks. It associates various information with domain names assigned to each registered participant. In one example, the DNS 402 may translate a name known to software executing on a client 436 to route data to one or more of switchboard node 404 of the switchboard system. In embodiments, the DNS 402 may generate into a number, such as an Internet Protocol (IP) address, an address record (A-record), or another Host name (C-name record). At a high level, the Domain Name System 402 translates known domain names to numerical Internet Protocol (IP) addresses needed for locating and identifying computer services and devices with the underlying network protocols.

In embodiments, a client 436 communicates with the switchboard system to perform one or more of the partner services 432. Once the client 436 identifies a switchboard node 404 and resolves an address to communicate with the switchboard node 404, the client 436 may send one or more messages to the switchboard node 404 to authenticate and perform one-or more operation. The switchboard node 404 includes an authentication 410 function that is configured to authenticate the client 436.

The switchboard node 404 may authorize or authenticate the client 436 or user, and the switchboard node 404 may utilize the additional components, such as the session and nonce generator 406 and message router 408, to perform control operations associated, for example, with generation of a user biometric signature and verification of biometric data provided at transaction time from a client device. Note the clients 436 may never directly interact with the validator and/or merchant systems, nor vice versa. The nodes 204 brokers all communication.

In embodiments, the switchboard system may utilize a hyperledger fabric 420 to manage synchronizing the shared operation data 412 and member management across the network. The hyperledger fabric 420 is distributed ledger framework having a permissioned network model that only authorized participants can join the network and access the data that is stored on a ledger.

In embodiments, the hyperledger fabric 420 may be generated by creating one or more set of peers, an ordering service, and a channel. Once the network is created, the system 400 deploys chaincode to the network or nodes 404 permitted to access the fabric. The chaincode is the code that runs on the blockchain and executes the network control 426 and operation data 412 logic code. Once the chaincode is deployed, each of the switchboard nodes 404 is configured to invoke transactions on the blockchain to add data to the blockchain, e.g., the operational data. A switchboard node 404 or another device can query the ledger to retrieve data. The ledger is a distributed database that stores all of the data that has been added to the blockchain.

All nodes 404 keep an independently verifiable log of their actions that can be transmitted to a centralized aggregator to build a picture of overall network usage. At a central level, system 400 can manage network operation data and management and have a centralized view of network use, aggregated and abstracted to the appropriate level.

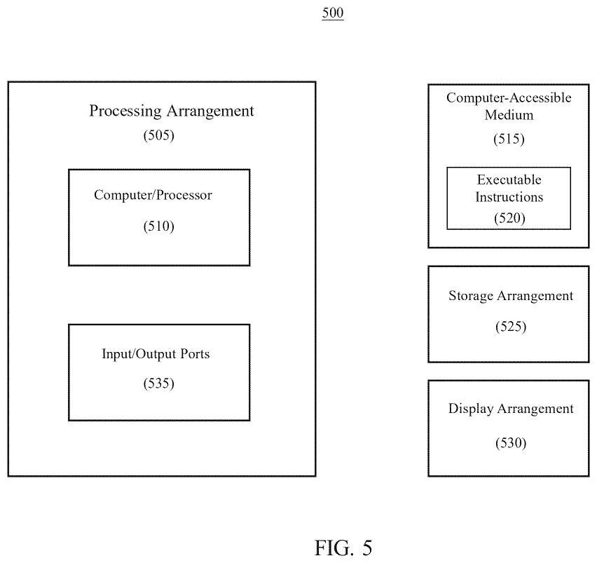

FIG. 5 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 505) may be configured for . . . . Such processing and/or computing arrangement 705 can be, for example entirely or a part of, or include, but not limited to, a computer and/or processor 510 that can include, for example one or more microprocessors, and use instructions stored on a computer-accessible medium (e.g., RAM, ROM, hard drive, or other storage device).

As shown in FIG. 5, for example a computer-accessible medium 515 (e.g., as described herein above, a storage device such as a hard disk, floppy disk, memory stick, CD-ROM, RAM, ROM, etc., or a collection thereof) can be provided (e.g., in communication with the processing arrangement 505). The computer-accessible medium 515 can contain executable instructions 520 thereon. In addition or alternatively, a storage arrangement 525 can be provided separately from the computer-accessible medium 515, which can provide the instructions to the processing arrangement 505 so as to configure the processing arrangement to execute the exemplary procedures, processes, and methods, as described herein above, for example.

Further, the exemplary processing arrangement 505 can be provided with or include an input and/or output ports 535, which can include, for example a wired network, a wireless network, the internet, an intranet, a data collection probe, a sensor, etc. As shown in FIG. 5, the exemplary processing arrangement 505 can be in communication with an exemplary display arrangement 530, which, according to certain exemplary embodiments of the present disclosure, can be a touchscreen configured for inputting information to the processing arrangement in addition to outputting information from the processing arrangement, for example. Further, the exemplary display arrangement 530 and/or a storage arrangement 525 can be used to display and/or store data in a user-accessible format and/or user-readable format.

Systems and methods described herein can provide a system and configuration establishing a biometric signature (e.g., an RBI) from a trusted source, and implementing secure operations associated with plurality of distinct service providers (connected across a central server and/or platform), such that various user account, tied to different service providers (e.g., participating members connected to an account-linking platform), may be securely accessed and managed by a user. The operations may include financial transactions (e.g., credit card and debit card transactions) whereby a user may select from a variety of financial account for completing a specific transaction, account management transactions (e.g., card refresh, card replacement, and new card addition transactions) wherein a biometric authentication established in connection to one account (e.g., first server) may be applied and accepted by other account inter-connected through the account-linking platform. Furthermore, membership transactions (e.g., joining and departing transactions), point of access transactions (e.g., building access and secure storage access transactions), transportation transactions (e.g., ticketing and boarding transactions), entertainment transactions (e.g., accessing media and/or games), and other transactions associated with a plurality of service providers may be securely accessed.

Other technical features may be readily apparent to one skilled in the art from the following figures, descriptions, and claims.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “merchant” is not limited to a particular merchant or type of merchant. Rather, the present disclosure includes any type of merchant, vendor, or other entity involving in activities where products or services are sold or otherwise provided.

The present disclosure includes example embodiments using NFC for contactless card communication, but it is understood that the present disclosure is not limited to a particular type of communication. Rather, the present disclosure encompasses other types of contactless card communication, such as Bluetooth, RFID, and Wi-Fi, along with NFC.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method of providing biometrically authenticated centralized access to multiple accounts, the method comprising:
generating, by a first server, a reference biometric identifier (RBI) from biometric data scanned from a user associated with a user account stored by the first server;
transmitting, by the first server, the RBI, to a central server linking a plurality of account servers including the first server;
responsive to a user transaction being conducted via a first application executing on a first device, generating, by the first application, a biometric data packet (BDP) from biometric data captured, by the first device, from the user, wherein the BDP is transmitted to the central server;
verifying the BPD, by the central center, based by determining a match between the BDP received from the first device and the RBI received from the first server; and
returning, by the central server, one or more payment credentials associated with the user from the plurality of servers.

2. The method of claim 1, further comprising displaying one or more payment credentials on the first device for selection of a desired payment credentials from one or more payment credentials returned from the plurality of servers, wherein the selected payment credentials is transmitted on behalf of the merchant, to a corresponding server for validation.

3. The method of claim 1, wherein the first device corresponds to a merchant POS device, and the user transaction corresponds to an in-person transaction being conducted at the merchant POS device, wherein the BDP is generated by the POS device from biometric data captures by a biometric sensor associated with the POS device.

4. The method of claim 3, wherein the BDP further comprises a digital signature generated by the merchant, the digital signature enabling a validation of a merchant's identity by the central server.

5. The method of claim 4, wherein the generation of the digital signature and validation of the merchant's identity based on the digital signature is implemented using a public key cryptography protocol.

6. The method of claim 1, wherein the first device corresponds to a user communication device, and the user transaction corresponds to an electronic transaction conducted at a merchant online checkout page, wherein the BDP is generated by the user communication device from biometric image data captured by a camera unit associated with the user communication device.

7. The method of claim 5, wherein the BDP is further accompanied by a one-time password (OTP) generated by a second device associated with the user and wherein the OTP is retrieved from the second device by the user communication device and transmitted to the central server along with the BDP.

8. The method of claim 7, wherein the second device corresponds to a contactless card storing user identification data, and wherein the user communication device is configured to communicate with the contactless card using near-field communication (NFC).

9. The method of claim 1, wherein verifying the BDP comprises transmitting, by the central server, the BDP to the first server, wherein the BDP received from the central server, is compared with one or more RBIs stored on the first server for a determining a match.

10. The method of claim 9, wherein a user identifier associated with the RBI is provided to the central server in response to a successful match, wherein the central server is configured to return payment credentials associated with the user identifier from the plurality of servers.

11. The method of claim 1, wherein one or more of the RBI generated by the first server and the BDP generated by the first device correspond to a vectorized scan of a retina associated with the user.

12. The method of claim 11, wherein the vectorized scan of the retina corresponds to a vector image of branching pattern of blood vessels associated with the retina.

13. A system for providing centralized multi-account access based on real-time biometric authentication, the system comprising:
a first application comprising instructions for execution on a first device, the first device comprising: a processor, a memory, and a sensor for capturing a biometric image associated with a user; and
a first server connected to a central server trust-linking a plurality of account servers including the first server; wherein the first server is configured to:
generate a reference biometric identifier (RBI) from biometric data scanned from the user, wherein the user is associated with an account stored on the first server;
transmit the RBI to the central server;
wherein the first application, executing on the first device, is configured to:
generate, in response to a transaction being conducted by the user via the first device, a biometric data packet (BDP)from biometric image data scanned from the user; and
transmit the BDP to the central server for verification against the RBI, wherein upon verification of the BDP one or more user payment credentials associated with user is returned from the plurality of account servers.

14. The system of claim 13, wherein the first device is further configured to display one or more payment credentials for selection of a desired payment account by the user.

15. The system of claim 13, wherein the first device corresponds to a merchant POS device, and the transaction being conducted by the user corresponds to an in-person transaction at the merchant POS device.

16. The system of claim 15, wherein the BDP is generated by the POS device from biometric image data retrieved by a biometric scanner associated with the POS device.

17. The system of claim 13, wherein the first device corresponds to a user communication device, and the transaction being conducted by the user corresponds to an electronic transaction conducted at a merchant online checkout page.

18. The system of claim 17, wherein the BDP is generated by the user communication device from biometric image data captured by a camera unit associated with the user communication device.

19. The system of claim 17, wherein the BDP is further accompanied by a one-time password (OTP) generated by a second device associated with the user and wherein the OTP is retrieved from the second device by the user communication device and transmitted to the central server along with the BDP.

20. A computer-readable non-transitory medium comprising computer-executable instructions that, when executed by at least one processor, perform procedures comprising the steps of:
generating, by a first server, a reference biometric identifier (RBI) from biometric data scanned from a user associated with an account stored by the first server, wherein information associated with the user and the account are provided to a central server linking a plurality of account servers including the first server;
receiving a biometric data packet (BDP), the biometric data packet being generated from biometric image data captured from the user at a first device, and received, by the first server via the central server; and
transmitting, by the first server, a validation message to the central server, upon determining a successful match between the RBI and the BDP received from the central server, wherein the validation message initiate the central server to return user information and account data from the plurality of server.
